(19) United States
(12) Patent Application Publication
(10) Pub. No.: US 2018/0285573 A1
(43) Pub. Date: Oct. 4, 2018

(54) VISUAL CRYPTOGRAPHY AND OBFUSCATION USING AUGMENTED REALITY

(71) Applicant: Telefonaktiebolaget LM Ericsson (publ), Stockholm (SE)

(72) Inventors: Patrik LANTZ, Lund (SE); Martin HELL, Malmo (SE); Bjorn JOHANSSON, Bjarred (SE); Bernard SMEETS, Dalby (SE)

(21) Appl. No.: 15/526,754

(22) PCT Filed: Jan. 29, 2015
(86) PCT No.: PCT/EP2015/051858

§ 371 Date: May 13, 2017

Related U.S. Application Data
(60) Provisional application No. 62/079,952, filed on Nov. 14, 2014.

(51) Int. Cl. G06F 21/60; G06F 21/62; H04L 9/14; H04L 9/32; H04L 29/06; H04L 29/08; G06F 3/01; G06T 11/60; G02B 27/01

(52) U.S. Cl. CPC G06F 21/602; G06F 21/6218; H04L 9/14; H04L 9/3228; H04L 63/067; G02B 2027/0134; G06F 3/013; G06T 11/60; G02B 27/0172; G02B 2027/0178; H04L 67/141

(57) ABSTRACT

A method and user device for preventing unauthorized viewing of at least one entity, e.g. character, digit, image and/or shape, is provided. The method comprises splitting up the entity in at least two parts, after which one of the split parts are sent to a first display unit and the remaining split part(s) is/are sent to at least one other display unit.

### TECHNICAL FIELD

The present invention relates to methods and devices for visual obfuscation and cryptography.

### BACKGROUND

Visual Cryptography and Barcode Verification

The original idea of visual cryptography is a secret sharing scheme where 2 or more n users can mechanically decrypt a visual image by overlaying the shares of the images, assuming transparency in the shares. A secret image is broken up into n shares so that the original image will only be decrypted by someone with possession of all the shares.

Recent research in privacy-preserving human-computer interaction allows authorized users to decipher data shown on a display, such as an electronic screen or printed material. In the former case, the authorized user can then interact with the system (e.g., by pressing buttons on the screen), without revealing the details of the interaction to others who may be watching or to the system itself. The user may view the decrypted data on a closely-held personal device, such as a pair of smart glasses with a camera and heads-up display (HUD), or a smartphone. The data can then be displayed as an image overlay on the personal device, which cannot be viewed by an adversary. The overlay is a form of augmented reality that not only allows the user to view the protected data, but also allows to the user to securely enter PIN input into the system by randomizing the input interface. This scheme can use any type of visual data encoding (e.g., QR codes, Data Matrices or Dataglyphs). This prior art attempts to prevent shoulder-surfing, as an adversary does not see what the user is observing and what is being entered on the screen. Moreover, a keylogger running on an infected host may not learn anything about the user input.

It is possible to hijack smart glasses using malicious QR codes. This highlights implementation flaws, but another scenario is QR code phishing attacks. However, there are solutions for verifying 2D codes such as QR codes based on signatures. Additionally, 2D barcodes have been used in earlier work for secure device pairing.

Haptics, Eye- and Gaze Tracking

Eye tracking has made much progress and different authentication methods have been developed where users gaze at a PIN pad in order to input their PIN code. Other work is related to biometric authentication since eye movement characteristics is individual and might be used in order to identify a user. In the field of biometric authentication there has been work that relies on haptics, i.e. nonverbal communication involving touch sensors which has been shown to work for user authentication.

Generic Authentication Architecture

Generic Authentication Architecture (GAA) is a standard made by 3GPP defined in TR 33.919. It provides fresh key material for clients and servers that require shared secret based authentication, and signs certificates for those applications which require asymmetric authentication. The users' equipment authenticate themselves to the operator's GAA service by existing 3G or 2G authentication protocols, and in the process receive new keys. Also the services, which the users want to use, are able to fetch them from GAA. This way the clients and servers are able to share secrets.

There has been previous work published where GAA is used for a one-time authorization code (OTAC) system and describing how to perform authentication to a service from a computer via a mobile device.

### Problems with Existing Solutions

Methods for eye- and gaze tracking together with biometric authentication such as characterizing eye movement will always come with an error rate that depends on many factors. Additionally, users may not be keen on the idea that their biometrical information might be stored in some place and potentially compromised.

Visual cryptography makes the assumption that there exists some sort of a shared secret between the end-user and the content device showing the encryption. When showing the secret information it is important to protect it against shoulder-surfing and malware with more evolved logging capabilities. Additionally, the user must be able to verify the content device.

In some prior art solutions it is mentioned how the keys are exchanged using ad-hoc methods for pairing the content device together with the end users mobile phone using Wi-Fi, Bluetooth or NFC and this requires an additional setup phase. Using smart glasses it is possible to setup and connect to a WiFi by scanning QR codes or authenticating to a service, but here as well it is required to provide credentials or verify the mobile device.

Other prior art methods rely on key establishment based on a master key being provisioned in the user device to be used with the content device. From this, a barcode acting as nonce is used in order to derive a key using a KDF at the UE and content device. However, it does not mention synchronization problems if two persons view the content screen simultaneously on a public terminal or if this is an offline authentication.

Future malware might employ techniques other than keylogging and instead focusing on HUD- and camera logging if authentication technologies emerge where smart glasses are used more widely. This is plausible as the glasses are voice controlled and therefore no keyboard input might be used and it might be attractive for an adversary to hijack the camera for various reasons.

There is no mentioning of how to protect users from phishing attacks in case a malicious content device wants to lure users to provide their PIN codes or other authentication credentials.

### SUMMARY

The present invention aims to improve problems of the prior art, and in particular a method and user device for preventing unauthorized viewing of relevant material is provided, thereby making it more difficult for an adversary to view the relevant material.

According to a first aspect a method for preventing unauthorized viewing of at least one entity is provided. The method comprises accessing original data relating to the at least one entity from a database requiring authorized access. The method further comprises splitting the at least one entity comprised in the original data or an encrypted version of the original data into at least a first split part and a second split part. All of the split parts are required in order for allowing visualization of the full extent of the entity. Furthermore, the method comprises sending the first split part as image data to a display unit of a pair of video glasses worn by an authorized user. Moreover, the method comprises sending the second split part as image data to a second display unit, whereby a super positioning of the first display unit and the second display unit allow for visualizing the full extent of the entity.

According to another aspect a user device comprising a mobile device with a screen and video glasses is provided. The mobile device screen and video glasses are interconnected and the mobile device is configured to perform relevant steps of the method according to the appended claims.

The solution according to the present invention is based on the concept of splitting information in two or more split parts. These split parts can be combined by overlaying or super positioning using augmented reality, for example using a terminal screen and a head-up display (HUD) in a pair of smart glasses. By splitting the relevant information up in several split parts, the full content of said relevant information is never in clear text except when the user combines the two parts and can interpret the full information.

The aligning of the at least two split parts can be performed manually or automatically e.g. using the camera. Different techniques can be used in order to simplify the aligning, e.g. adding features on the screen that are easy to find and locate in high precision for the camera.

More than two split parts, e.g. three or more split parts, can be utilized when the two split parts are sent to an autostereoscopic display unit screen and remaining split parts being sent to one or more display units of the pair of smart glasses.

The relevant information may include at least one entity, e.g. character, digit, letter, shape, or image, the whole extent of which not being able to be realized without having access to all of the associated split parts and how they are to be presented on each of the associated display units.

In order to visualize the whole extent of the relevant entity, one split part may be sent to a terminal display unit screen and another split part may be sent to the HUD of the smart glasses.

When the entity relates to a digit or number of digits, e.g. PIN code or one-time-access code (OTAC) where digits are represented using digital number fonts, some parts of the digits in plain text may be sent as first split part to the terminal display unit screen while the remaining parts of the digits are sent as another split part to the display unit HUD in the smart glasses. The plain text approach is referred to as the obfuscation approach in the associated embodiments of the present invention.

Alternatively, the part(s) of the entity(ies) is/are not sent as a plain text split part. The non-plain text approach is referred to as the visual cryptography approach in the associated embodiments of the present invention. In the visual cryptography approach, visual cryptography is applied to the entity(ies) where each resulting split part is not shown on the associated display unit as plaintext. The visual cryptography approach is adapted to work using a pair of smart glasses.

In one embodiment, the decryption and deobfuscation of the split parts performed presenting the split parts resulting from either the obfuscation approach or visual cryptography approach on at least two display units, one of which being included in the pair of smart glasses. The split part data is only in plain text when the user can actually see it in clear as in the obfuscation approach. Otherwise it is always encrypted as in the visual cryptography approach.

An advantage of the present invention is that it allows for decreased risk of successful shoulder surfing. Moreover, it provides means for making it more difficult for an adversary of obtaining the relevant information, by splitting up the information required to view the relevant information in at least two display units.

The splitting up of data according to the embodiments herein may be conducted either by using the obfuscation approach or the visual cryptography approach.

For example, in a phishing attack, it is required to know how the data splits are performed. If the content device (CD) is phishing for PIN inputs and generate incorrect digit splits and display these to the user equipment (UE), it will not form any meaningful digits when the HUD of the pair of smart glasses overlays or super positions the split parts with the associated split parts known by the CD.

The present invention according to some embodiments prevents shoulder-surfing while making it harder for advanced mobile-device malware with HUD and camera logging capabilities to learn about user credentials. By splitting up the required information between at least two display units, substantial work is required for an attacker to combine the data splits by observing the HUD display and performing camera recording during user authentication which is far better than today's solution to simply display all sensitive information in the HUD. By splitting the data into more than two pieces, using autostereoscopic displays will make this even harder.

The solution of the present invention can be combined with other solutions related to biometric authentication, for example eye- and gaze tracking or haptic authentication. The same goes for use of GBA protocol to provision the data split information between the UE and CD, which is optional and works for offline provisioning solutions as well.

In the event the split data information is provisioned between the CD and UE using GBA, then the service for which the user in authenticating against is not required to generate and keep track of the user's data splits, but can instead focus on verifying that the credentials are correct. According to some embodiments, the solution of the invention can be used for numerical and/or alphabetical authentication credentials or for one-time authorization code (OTAC). It can also be used for displaying sensitive material. The data split could also consist of shapes, coloring schemes or figures.

Both the visual obfuscation and cryptography methods can be used mechanically.

Visual cryptography method can also be split into three partitions using the described method with an autostereoscopic display. The advantage is that if an attacker has two of the three partitions, he will not be able to determine the plaintext as opposed to visual obfuscation where having two of three there is a possibility to guess the obfuscated values.

### BRIEF DESCRIPTION OF THE DRAWINGS

The present invention will be described in further detail under reference to the accompanying drawings in which:

FIG. 1 shows flow chart of a method according to an embodiment;

FIG. 2 shows flow chart of a method according to an embodiment;

FIG. 3 shows the a concept of the invention showing how an to construct an encrypted image of an original image and a created OTP according to an embodiment;

FIGS. 4 and 5 show the appearance of an encrypted image according to an embodiment;

FIG. 6 shows three digits originating from an original image shown by super positioning at least one created OTP and an encrypted image of the original image according to an embodiment;

FIG. 7 shows another example of three digits originating from an original image shown by super positioning at least one created OTP and an encrypted image of the original image according to an embodiment;

FIG. 8 shows flow chart of a method according to an embodiment;

FIG. 9 shows possible partitions for a 7 partition digit of an LCD display to the left and the digit 4 to the right being composed of partitions 0, 1, 4, and 6.

FIG. 10 shows an image being presented on one display unit comprising a number of split parts of digits;

FIG. 11 shows the appearance of the image of FIG. 10, when super positioned with an image, e.g. displayed by another display unit, containing the remaining split parts of each digit;

FIG. 12 a number of possible entities in the form of letters being possible to use for authorization according to an embodiment;

FIG. 13 shows the letter A in an LCD display having 16 partitions; and

FIG. 14 shows the invention implemented in a generic bootstrap architecture environment.

### DESCRIPTION OF EMBODIMENTS

The present invention generally relates to a post-authentication step involving splitting up visual information including at least one entity, e.g. character, digit, letters, shapes, and/or images, so that a first split part of the information is displayed on a first display unit, e.g a head-up-display (HUD) in a pair of video glasses, while the other split part(s) is/are displayed on a second display unit, e.g. a mobile device screen or computer screen. The different techniques of splitting up the original data comprising the entity and what split part is shown where, could e.g. be determined during an authentication, e.g. between the mobile device and a content service provider (using the shared secret), but one cannot determine from a single split part the appearance of the other split parts.

In an embodiment, according to FIG. 1 a method 10 for preventing unauthorized viewing of at least one entity is provided. The method comprises accessing 11 original data relating to the at least one entity from a database requiring authorized access. The method further comprises splitting 12 the at least one entity comprised in the original data or an encrypted version of the original data into at least a first split part and a second split part, wherein all of the split parts are required in order for allowing visualization of the full extent of the entity. Moreover, the method comprises sending 13 the first split part as image data to a display unit of a pair of video glasses worn by an authorized user. Furthermore, the method comprises sending 14 the second split part as image data to a second display unit, whereby a super positioning of the first display unit and the second display unit allow for visualizing the full extent of the entity.

The relevant information may include at least one entity, e.g. character, digit, letter, shape, or image, the whole extent of which not being able to be realized without having access to all of the associated split parts and how they are to be presented on each of the associated display units.

In an embodiment, the method 10, 20, 80 further comprises establishing 101 a session between a user device and a service/content provider; and exchanging 102 encryption keys such as to allowing the accessing of original data.

The Visual Cryptography Approach

A traditional visual encryption scheme uses two components created as a number of black and white sub-pixels. These two components are superimposed to reveal the original image. It is known to use a one-time-pad (OTP) with the same size as the original image as the first component and creating an encrypted image by taking the XOR of the original image and the OTP. In order to create a XOR visually each pixel in the original image is represented by a pair of, or 4 sub-pixels and the super-impose is performed by pixel-wise addition. This creates an image which has all white sub-pixels where the original image was 1 and half white/half black where the original image was 0.

In contrast to the traditional visual encryption scheme the present invention provides a different approach. Instead of having two components consisting of black and white sub-pixels one split part to be displayed to a first display unit comprises black and white sub-pixels, and the other split part to be displayed on second display unit in a pair of smart glasses or video glasses comprises white and transparent sub-pixels. The video glasses dominates the screen meaning that a white pixel in the glasses will make the corresponding pixel in the superimposed image white regardless of the value on the screen for this pixel. For a pixel position that is transparent in the glasses the superimposed image will get the value that the screen has for this position. By representing black/transparent as 0, i.e. “zero”, and white as 1, i.e. “one”, super positioning is conducted by pixel-wise OR (or MAX).

The creation of the encrypted components is performed as follows. First a temporary one-time-pad (OTP) is created with the same size as the original image consisting of ones and zeroes. We then represent a “one” in the temporary OTP e.g. by four sub-pixels forming a sub pixel matrix in a new OTP with white sub pixels on the diagonal, i.e.

$$[ \begin{matrix}W & T \\ T & W\end{matrix} ]$$

and a “zero” by two transparent pixels on the diagonal, i.e.

$$[ \begin{matrix}T & B \\ B & T\end{matrix} ] .$$

Optionally “one” results in an sub pixel matrix

$$[ \begin{matrix}T & W \\ W & T\end{matrix} ]$$

and “zero” results in a sub pixel matrix

$$[ \begin{matrix}B & T \\ T & B\end{matrix} ] .$$

This larger image comprising all of the sub matrices is now used as the OTP The OTP forms the first split part which is sent to a first display unit in the video glasses. An encrypted original image to be displayed as a second split part on a second display unit, e.g. the mobile device display screen or computer screen, is then created with the following rule, assuming black digits on white background.

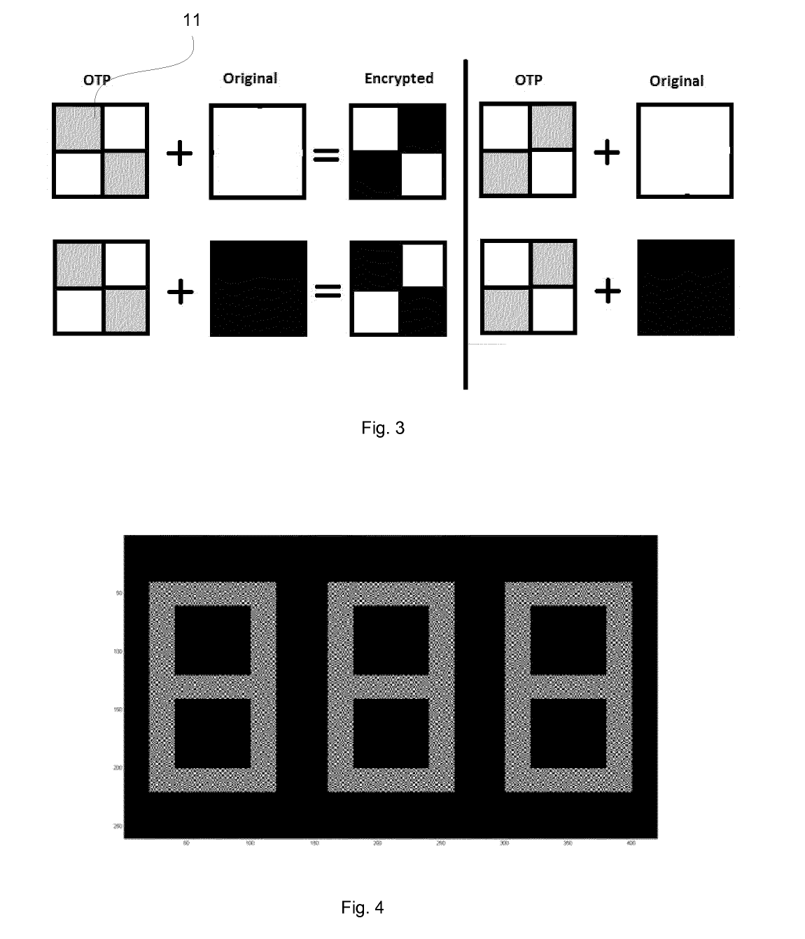

With reference to FIG. 3, if the original image pixel is white and OTP

$$[ \begin{matrix}W & T \\ T & W\end{matrix} ]$$

or the original image pixel is black and OTP is

$$[ \begin{matrix}T & W \\ W & T\end{matrix} ]$$

then let the encrypted pixel be represented by

$$[ \begin{matrix}B & W \\ W & B\end{matrix} ] ,$$

otherwise represented by

$$[ \begin{matrix}W & B \\ B & W\end{matrix} ] .$$

This way the black pixels of the second split part being displayed on the second display unit are placed so that they are ‘covered’ by white pixels of the first split part being displayed in the video glasses when one wants to create a white pixel in the superimposed image, but placed to be seen through the transparent pixels in the glasses when we want to create a black pixel in the super-imposed image. This corresponds to creating encrypted image by taking the exclusive or (XOR) of original pixel value and OTP.

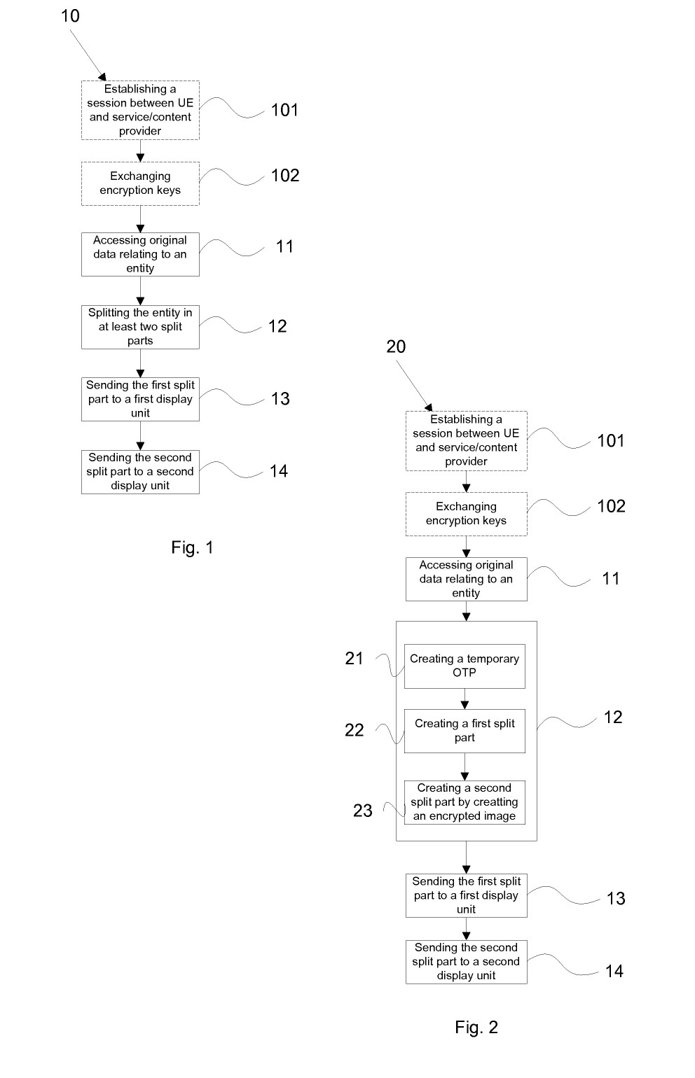

In an embodiment, according to FIG. 2, a second method 20 for preventing unauthorized viewing of at least one entity is provided. Here, the original data relates to an original image. The first split part is formed as a one-time-pad (OTP), the first split part OTP having a size at least corresponding to the size of the entity of the original image or larger, and wherein the second split part is formed as an encrypted image version of the original data.

The steps of the second method corresponds to those of the first method 10 but provided with further details regarding how the at least two split parts are created. The second method 20 a one-time-pad for the first split part is created by creating 21 a temporary OTP having the same size as the original image with either a “one” or “zero” for each pixel position of the original image. Moreover, the first split part OTP is created by representing each pixel of the temporary OTP with at least four sub pixels forming a sub pixel matrix for each pixel of the temporary OTP, wherein the first split part OTP comprises each sub pixel matrix, wherein the first split part OTP has a size being at least four times larger than that of the temporary OTP. Here, each “one” in the temporary OTP is represented by “white” sub pixels on a diagonal of the associated sub pixel matrix and with “transparent” pixels at the other positions of the associated sub pixel matrix. Moreover, each a “zero” in the temporary OTP is represented by “transparent” pixels on another diagonal of the associated sub pixel matrix and with “white” pixels at the other positions of the associated sub pixel matrix.

The second split part is according to the second method 20 created by creating 23 an encrypted image of the original image, wherein the encrypted image comprises a number of encrypted sub pixel matrices, each encrypted sub pixel matrix being associated with one sub pixel matrix of the first split part OTP. Here, each encrypted sub pixel matrix is represented by “black” sub pixels on the diagonal thereof and with “white” sub pixels on the other positions thereof. Accordingly, when the corresponding pixel of the original image is “white” and the sub pixels of the corresponding diagonal of the first split part OTP for the corresponding pixel is “white”, or when the corresponding pixel of the original image is “black” and the sub pixels of the corresponding diagonal of the first split part OTP for the corresponding pixel is “transparent” the sub pixels of the corresponding diagonal of the associated encrypted sub matrix are represented by “black” sub pixels and with “white” sub pixels on the other positions thereof. Otherwise the corresponding diagonal of associated encrypted sub matrix is represented by “white” sub pixels and with “black” sub pixels on the other positions thereof.

In an embodiment, the OTP is preferably generated by the service displaying the encrypted image or mobile operator (if GBA is used) and provisioned to the user.

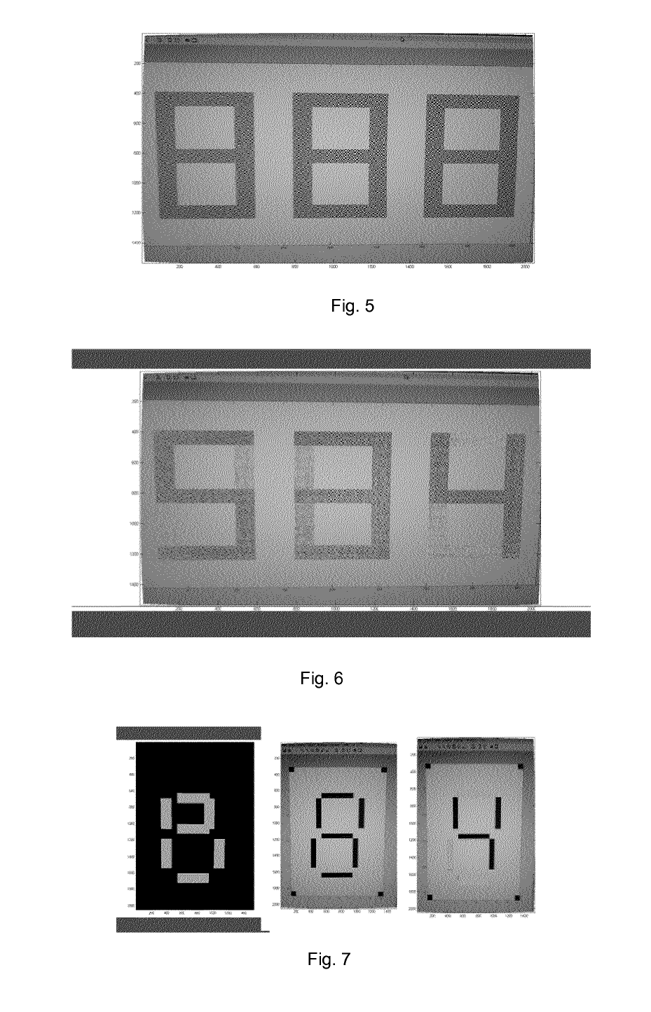

The visual cryptography approach may be used to encrypt entities, e.g. digits, characters, letters etc., which are visually revealed when the two split parts are super-imposed. FIG. 4 shows a randomized OTP where to each pixel in the original image we have created 2×2 sub-pixels, i.e. a 2×2 sub-pixel matrix. FIG. 5 shows a picture of the encrypted split part data when visualized on a second display unit captured by a camera. For each pixel in the original image a 2×2 pattern for the encrypted image was created according to the above. Estimated camera parameters were used to compensate for radial and tangential distortions in the picture. The transformation used for warping the OTP to match the picture was estimated manually but could be estimated automatically using standard techniques in computer vision; alternatively the screen and head could be rotated and tilted so that the components match. The superimposed result is shown in FIG. 6, where the original entities 5, 3, 4 may be observed.

Image Distorsions

Due to the following sources for errors the visual super positioning, i.e. decryption, is not perfect. One source of distortion arises from image distortions due to imperfect camera (e.g. nonlinearities). Another distortion error source relates to ‘bleeding’ of white areas into black in picture smoothing OTP. A third source of distortion error relates to the fact that the estimated transformation may not perfectly warp OTP to picture.

The 2×2 subpixel matrix representation used in the example above is only one possible option. In the following example we only use two sub-pixels/bars for each line-segment in the model that is used to create the digits. In the OTP and in the encrypted image one of the two pixels/bars for each line-segment is set. For the line-segment that are set in the original image to create the digit, the OTP and encrypted image will have different sub-pixels/bars set and the other line-segments will have the same sub-pixels/bars set. In the superimposed image the digit will appear in the clear. Note that in the example below the OTP sub-pixels/bars are created larger than in the encrypted image, in order to make the system less sensitive to the errors mentioned before.

The visual cryptography approach is at least associated with advantage that it is very difficult for an adversary to guess the correct digits without accessing both the first split part and the second split part. Since the OTP for each original image comprises a great number of sub pixel matrices, each sub-pixel matrix being either

$$[ \begin{matrix}W & T \\ T & W\end{matrix} ] , [ \begin{matrix}T & W \\ W & T\end{matrix} ] , [ \begin{matrix}T & B \\ B & T\end{matrix} ] , or [ \begin{matrix}B & T \\ T & B\end{matrix} ]$$

it is very difficult to adequately guess the correct associated entity by only observing the encrypted image presented on the second display unit.

The Obfuscation Approach

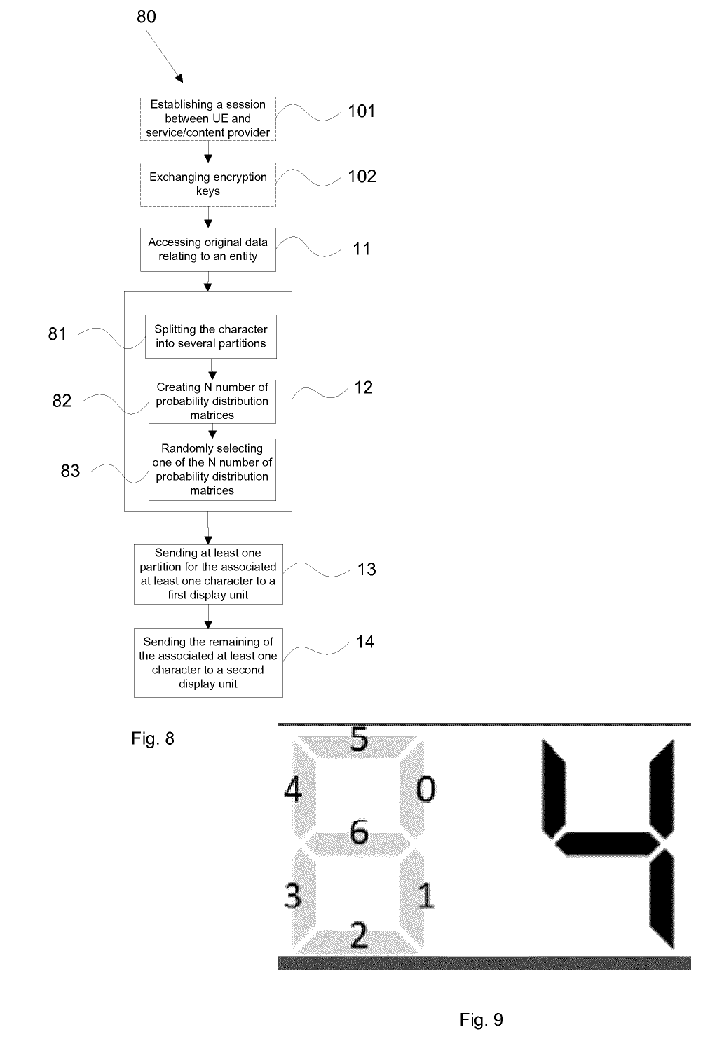

In an embodiment, according to FIG. 8 a third method 80 for preventing unauthorized viewing of at least one entity is provided. The method shows similar steps to that of the method of FIG. 1, but with further details regarding how the at least two split parts are created. Here, the entity relates to at least one character, e.g. such as a digit, letter etc.

In the third method 80 the splitting 12 comprises splitting 81 the character into several partitions, each split partition being associated with a unique probability of representing a specific character, wherein the unique probabilities for each partition are represented in a probability matrix, and wherein the probability matrices for all possible partitions are represented in an original probability distribution matrix. The splitting 12 further comprises creating 82 N number of new probability distribution matrices, wherein each new probability distribution matrix has probability entries being randomly changed in view of the corresponding to unique probability entries of the original probability distribution matrix. Moreover, the splitting 12 further comprises randomly selecting 83 one of the N number of new probability distribution matrices and the original probability matrix. The method 80 further comprises sending 14 at least one partition for the associated at least one character as a second split part as image data to the second display unit according to the selected probability distribution matrix, and sending 13 the remaining partitions for the associated at least one character as a first split part as image data to the first display unit.

It should be noted that the partitions selected for each character could be chosen according to a “custom” distribution. Based on this “custom” distribution the each partition could be displayed onto a specific display unit randomly. Once, one or more partitions have been selected for display onto one display unit, the remaining or complementary partitions for the associated character can be displayed onto the other display unit(s).

In order to facilitate the understanding of the obfuscation approach according to some embodiments of the present invention, the entity in some examples given herein relates to a digit, which e.g. could be a digit of a PIN code.

While entering for example a PIN code it is not desired to reveal the PIN code in case of shoulder-surfing.

The visual obfuscation is designed in such way that even with visual information from the first display unit, e.g. HUD in the video glasses, it will not be possible to determine the information shown on the second display unit, e.g. mobile device screen, and what digits we are pressing if we are entering a PIN code.

It should be appreciated that the obfuscation approach leaks some information about the plain text. However, the adversary/attacker can only guess what the plain text is according to a probabilistic analysis.

The adversary could perhaps combine the two split parts, but it is cumbersome and requires computer vision techniques to do this automatically. An alternative is to assume that the camera can be disabled in some way, e.g, by directing a pulsing light at the camera and blinding it, however it is just an assumption that one could make.

A third alternative is the autostereoscopic (see below for further details) approach where the third part will be missing, but this increases the probability to guess correct.

Splitting Digits

In a first example of the obfuscation approach LCD fonts are considered to represent digits since these can easily be divided into several parts. FIG. 9 shows the partitions or lines numbered 0 to 6 that can make up all possible digits zero to nine. The digits can be encoded using the binary sequence x₁, x₂ . . . x₇ where

$${x}_{i} \{ \begin{matrix}1 , & line i in use \\ 0 , & otherwise\end{matrix}$$

An example, digit four in FIG. 9 may be encoded as the sequence 0111010. A split into two split parts for digit four may be for example 0110000 and 0001010. With these split parts there is a very small probability to guess correctly because there are multiple digits to choose from that also can be split this way. Which partitions are used for each digit can be randomly selected which gives an equal probability distribution for the different partitions that can form a digit. The choice of how to split up each digit is preferably not static, thereby making it more difficult for an adversary to realize the correct digit. Instead, a distribution of different split partitions may be used.

In an example the present inventors calculated the probability of guessing the correct digit for a PIN pad case, where each digit 0 to 9 must be used and only once (no duplicate digits can occur), by only having access to one split part to be 0.3743 if the adversary knows the distribution that is used when the partitioning the digits.

For the OTAC case it is possible to control which digits to show to the user compared to the PIN pad case where each digit 0 to 9 must be present once and only once. For example, in the OTAC case it is possible to choose to use certain digits that are easier to guess less frequently. Hence, for the OTAC case it is possible to construct a different distribution or a random partition distribution and if the attacker uses the equal probability distribution then the probability to guess correct is decreased to 0.2833 for each digit. Hence, for a two digit code then the chance of guessing all digits correctly is 0.2833²=0.08=8%.

Each digit and partitions of the digits may be assigned a different probability. These different probabilities for each digit may be collected in a matrix denoted as the distribution matrix.

For the OTAC case several distribution matrices could obtained. The distribution matrices could be generated beforehand. Provided that the adversary does not know which distribution matrix being used this several number of distributions will make it difficult for the adversary to guess correctly. The aim of providing several distributions for each digit is to minimize the probability for an adversary to guess the digits correct when he is observing one of the partitions. Before the digit is split up, a distribution out of many could be selected, e.g. randomly, thereby making it even more difficult for the adversary to guess the correct digit. Optionally a specified strategy of how to select amongst the several distributions may be used.

Once a specific distribution matrix has been selected, a partition for each digit in the distribution matrix is selected. Subsequently, the selected partition(s) for each digit is sent as a first split part to the first display unit and the remaining partitions of the digit to at least a second display unit. The process of selecting a distribution, selecting partitions, and sending split parts to different display units could be executed locally or it can be done e.g. by generic bootstrapping architecture (GBA) servers or by a service/terminal host.

A specified strategy could consider the following.

One example of a condition is whether the digits must appear at least one time (e.g., in a PIN pad) or if one may choose digits freely like in the OTAC scenario.

Another condition can be that the attacker knows what distribution is used. Then it is possible to adjust the strategy by using several distributions. To summarize, there is not only one optimal distribution for all scenarios but the strategy to choose partition is dependent on the conditions.

In an embodiment, it is preferred that the PIN pad is randomized on each session, but how the digits are split must be static because an adversary can learn new information in each session if the digits are split differently each time.

Splitting Letters

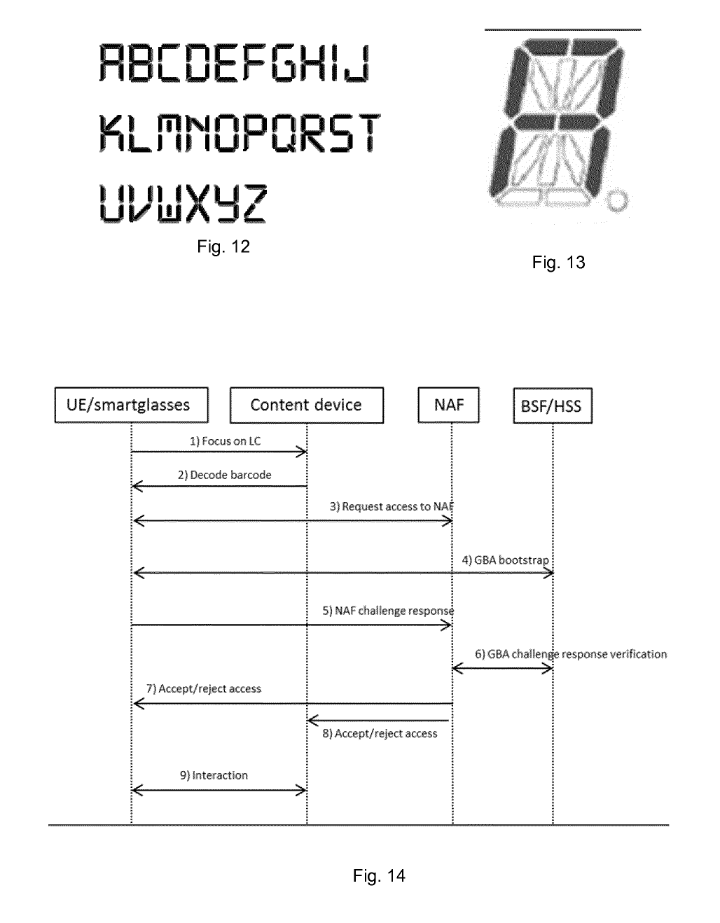

In previous section entities in the form of digits were discussed for purpose of PIN code authentication. The entity is however not limited to only digits according to the embodiments of the present invention. In this section entities in the form of letters are further explained. In order to represent all different letters and characters, one can use a LCD font similar to the one in the digit split case but modified a bit as shown in FIG. 12 using the DS-Digital font or a similar variant as shown in FIG. 13.

The present invention according to some embodiments may be utilized to provide secure reading of sensitive materials and still preventing shoulder-surfing and obscuring camera logging malware. If the user equipment and the content device (CD) share a secret, in this case how the splitting of the letters is done, then generic bootstrapping architecture (GBA), described further in detail below, is optional for this setup and one may have offline interaction. The CD application can generate a random split of the letters in a text and inform the application in the UE what to show in the HUD of the video glasses a simple interaction between the UE and CD as step 1 and 2 in FIG. 14. Once again, each unique piece of text should have a static split of letters so that an observer may not learn the full text if capturing several obfuscation sessions.

Splitting Shapes and Images

A general image with arbitrary shapes/figures can be split in a similar way using a codable and systematic partitioning pattern covering the image.

The Display Units

The visual information displayed on the HUD of the video glasses could for example be captured by a single camera within the video glasses and directed towards the HUD. However, by presenting different split parts to another HUD of the same video glasses which cannot be registered by the single camera then the single camera only captures the split part being e.g. displayed in front of the right eye of the user. Hence, the split part from displayed on a HUD in front of the left eye may not be determined accurately to make up all split parts of the digits.

A similar attack could potentially be performed on a user without smart glasses by directing a camera and capturing the reflection in the eyes. In such an event a solution could be to use an autostereoscopic display (see below for further details).

In an embodiment, the first display unit is a transparent type (glass) and the second display unit is of a non-transparent type (screen).

Three Display Units

Splitting up the relevant entity information up in more than two split parts allows for an even higher degree of security.

In an embodiment, the splitting further comprises splitting up the at least one entity in a first split part, second split part and at least one further split part, and wherein the at least further split part is displayed on a third display unit.

In an embodiment, the third display unit and the second display unit may be comprised in a stereoscopic display unit being of an auto-stereoscopic or polarized stereo display type.

In an embodiment, the third display unit and first display unit is comprised in the video glasses, optionally as two Head-Up-Displays (HUDs) arranged in the video glasses.

While entering for example a PIN code it is not desired to reveal the PIN code to a HUD- and camera logging capable malware. This is prevented in one embodiment by splitting digits in three different split parts, one split part (actually two split parts) may be displayed on an autostereoscopic screen, e.g. touch screen, in which case the right and left eye see different information due to different images being displayed for the eyes. The final split part is shown in the HUD of the video glasses, e.g. placed in the right-eye channel. It is foreseen that it can be two HUDs in the glasses, one in the left-eye and the other in the right-eye channel. Aligning the glasses and eyes to the screen provides full visual information about the digits.

When using three split parts, then there are more possible combinations of selecting partitions to show on each display unit than for the two split part case. This makes it even harder for an adversary to find out the correct entities, when only having access to one or two of the split parts.

If a malware has total control over the mobile device and glasses, it can read the HUD information and hijack the camera. However, the risk of having malware in both the mobile device and the camera(s) in the video glasses is considered being much smaller than having malware in only one of the display unit devices.

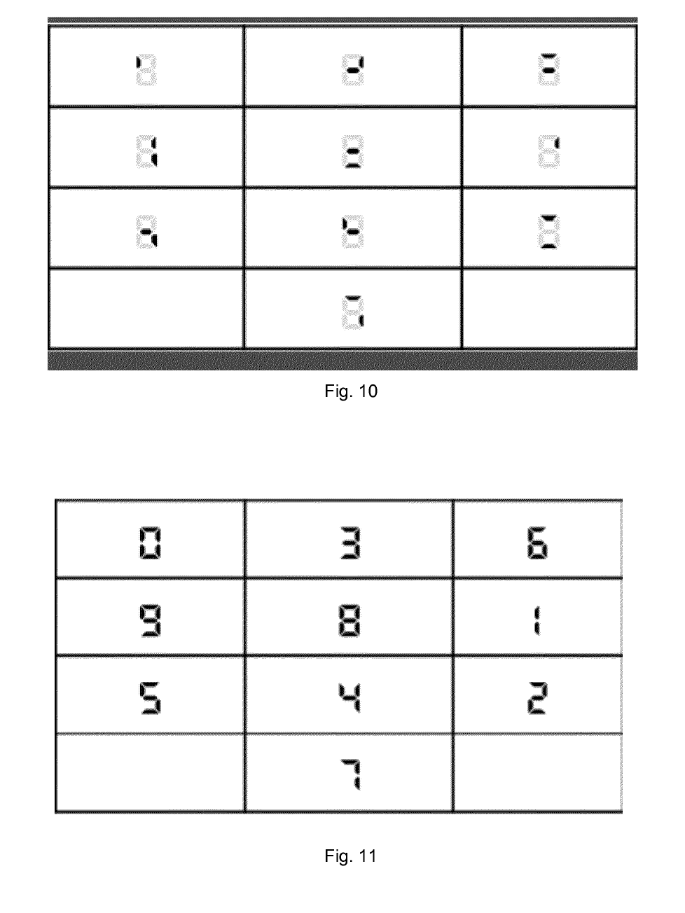

By using an autostereoscopic screen, touch screen the right and left eye will receive different images and if the camera is located at the right side, it will only capture what the right eye can see at best. Eye tracking could be taken into account because the image on the HUD screen could be updated whenever the user moves around the head and it is desired to prevent the camera from capturing the image designated for the left eye. If a camera logging malware is able to capture the image for the left eye, then the malware learns everything about the PIN pad layout and how the digits are split. That is if one assumes that the malware has total control over the UE and it can read information being displayed in the HUD of the glasses and at the same time record the PIN input using the camera. As an example, FIG. 10 shows a PIN pad with information shown on the screen that a camera can capture and the overlay information shown in the HUD and let's assume the rest is only visible to the left-eye of the user, i.e., the malware has no knowledge of it. Each PIN pad button has multiple choices to choose from. The user on the contrary will see what is displayed in FIG. 11.

In case of shoulder-surfing, the adversary will only be able to see the parts of the digits that are displayed for the right and left eye, but autostereoscopic displays with eye tracking are normally only used for a single viewer so the adversary must be in the same sweet spot as the user to see the information being displayed.

The autostereoscopic display is optional. A camera can be disabled in different ways, for example by directing a pulsing light at the lens in order to distort any imagery the camera records. If one assumes that the camera is enabled and is worried about camera logging malware, it is still possible to split the entity information in two parts but instead combine this with biometric input such as eye- and gaze tracking capabilities or using haptic authentication. In this case, even if the malware can capture the whole authentication session and combine the partitionings, he will not be able to reproduce the input as it relies on user biometrics.

In an embodiment, a user device comprising a mobile device with a screen and video glasses is provided. The mobile device screen and video glasses are interconnected. The mobile device is configured to perform relevant steps of the method according to the embodiments herein. Here, the mobile device screen equates the second display unit and the video glasses comprise the first display unit.

In an embodiment, the mobile device screen is auto-stereoscopic.

In an embodiment, software resides in any or both of the mobile device and the video glasses.

### APPLICABILITY

Biometric Data

In another embodiment the OTP used in the glasses to view the decrypted message may be dependent on biometrical authentication of the user. E.g. information from a retina scan or fingerprint may be used to generate the OTP. If the glasses are used by someone else another OTP will be generated which will not ‘decrypt’ the encrypted message. Alternatively the biometric information is used to create a third layer used together with a key-based OTP to ‘decrypt’ the encrypted message.

Authentication

In an embodiment, with reference to the second method, the method comprises receiving the first split part OTP and the second split part when the encryption keys between the user device and the as service/content provider have been exchanged.

In an embodiment, the first split part OTP is used both as encryption and decryption key.

In an embodiment, the first method, second method or third method further comprises sending the user input data, i.e. entity related data resulting the from super positioning of the first split part and the second split part, pin code, one-time authorization code, to a receiver e.g. of the service provider having knowledge about the original data or at least what part of the data that is encrypted and how it is encrypted for gaining access to authorized data e.g. authorized data from the service provider. The method further comprises receiving the user input data at the receiver, and at the receiver authorizing the user to access the authorized data when the user input data matches the at least one entity required.

Authentication Using Generic Bootstrap Architecture

The present invention could be used as an integrated part of any known authentication protocol, e.g. NFC, GBA, etc. The GBA scheme is described further in detail below.

When the present invention is implemented in a mobile device, e.g. smart phone, and a pair of smart glasses, provisions are made for it to work in this mobile setting.

As a non-limiting example, for this purpose it is possible to utilize generic boot strapping GBA for provisioning for the obfuscation approach as well as the visual cryptography approach. In the visual cryptography approach the OTP and encrypted data is provisioned to the UE and terminal screen host using the protocol described. In obfuscation approach the provisioning may include the entity (digit/letter) partitions for the UE and terminal host and for a PIN pad case. Information is also appended for the randomized PIN pad layout. The present inventors have realized that the distributions of the partitions may be advantageously varied in order to even further making it more difficult for an adversary to successfully access the relevant entity information. Hence, from a group of available distributions then a random distribution can be selected for each specific user from the class. For example, each authentication session may use different distribution. This will make it harder for an adversary to guess correct if the distribution is not known. However, GBA is not mandatory and this provisioning can be implemented in several ways, e.g., with pre-shared secrets between the UE and terminal or using PKI.

FIG. 14 shows an example of the implementation of the invention into a commonly known generic bootstrap architecture GBA authentication environment.

In a general bootstrapping architecture, initially the user focuses on a Login Container (LC) on the content device (CD). Using an app for reading machine-readable codes, e.g. QR codes or barcodes, the user equipment (UE) decodes the barcode (step 1-2). This barcode may contain necessary information about the Network Application Functions (NAF) and any other universal resource locator (URL), and optionally a challenge, so we treat this interaction with the barcode as step 3 of FIG. 14.

The Login Container (LC) on the content device (CD) typically resides in a device with a screen and user interface but the machine-readable code could also be printed on any surface. The NAF is the Service/Content Provider. The Content device (CD) with Login Container (LC) can also be same as NAF, i.e. the service the user is interacting with. The Bootstrapping Server Function (BSF)/Home subscriber server (HSS) is a node in the mobile network used in GBA.

Optionally the user may somehow trigger the CD, e.g., touching a button or screen, to initiate the procedure. In response a new barcode is generated including CD identification/authentication information. At the same time the CD may send a commitment of this authentication information to the NAF, shown as 3* in FIG. 14. After that the CD will wait for response of the NAF and additional interaction from the UE and its user.

The UE performs GBA bootstrapping with the BSF (step 4.) and then the NAF challenge response is sent to a URL specified by the NAF in the barcode (step 5). The NAF performs a GBA challenge response verification (step 6). If it succeeds the UE is allowed to interact with the CD (step 7-9). The UE and NAF will have a shared key Ks_NAF that can be used for symmetric visual cryptography.

The present inventors have realized that other content than the shared keys may be used for authentication using GBA. Hence, instead of just calculating challenge responses and verifications (step 4 and 6), information relating to how the entitiy(ies) are split up in split parts according to the embodiments herein, may be included as part of the GBA algorithm, e.g. as an add-on functionality in step 4 of FIG. 14.

Digit splits for each number are encoded as sequences s₀, s₁ . . . s₉ representing each digit in the PIN pad in the order as they are displayed (order is randomized). The user equipment (UE) will therefore need to receive 10*7=70 bits=8.75 bytes in addition to the standard GBA protocol data (step 4 in FIG. 14). However, the NAF must also know how the BSF has randomized the PIN pad so it can verify PIN input from the users. For each PIN pad button a binary sequence of length four is appended to the sequences of digits splits. These changes will for the NAF require receiving 70+(10*4)=110 bits=13.75 bytes of overhead compared to the standard protocol (step 6 in FIG. 14). Labels for identifying digit split information in the GBA protocol in not included in the overhead.

GBA with Split Part Information and with Biometric Data

In an embodiment of the invention, biometric data is used together with GBA. Usually, GBA identifies mobile devices based on the mobile device identity, but here it can identify users based on the biometric authentication as well.

For example, a user may use voice recognition to authenticate himself, smartglasses often being provided with voice control. Then it is possible to create a unique split of entities or OTP for each individual. In the known application of GBA, only the mobile device is identified and authenticated. With this embodiment, another user of the glasses will not be authenticated and will not receive the true split of characters or OTP.

Bar Codes

In an embodiment a way to authenticate to services and setup secure connections by simply looking at a barcode, scanning and decoding it is provided. This relies on the fact that it is possible to decode information with smart eyeglasses, much like it is possible to do with a smartphone and a barcode reader application. The visual data can be encoded using barcodes such as QR codes. An authentication can be performed in the public on a digital screen showing a barcode or on a printed barcode using GBA. After authenticating it is possible to setup a secure connection using visual encryption as both parties have a shared secret or via a conventional secure-connection using TCP/IP.

In an embodiment, an exemplary method is provided including the following steps is provided.

Step 1) Initial step, user walks up to a screen (Content device CD with Login Container LC or NAF), that is the service the user is interacting with and the glasses capture a visual encoding, e.g., a QR code. This code may contain necessary information for step 4).

Step 2) Captured visual encoding is decoded in the glasses, if there is support for this. In this case the glasses forward the decoded information to the mobile device. Otherwise, the glasses forward the QR code to the mobile device which decodes it.

Step 3) A biometric authentication is performed. The user may for example use speech recognition (as glasses are voice-controlled) in order to authenticate himself. Alternatively, a fingerprint or retina scan can be performed. This authentication can be performed by the mobile device or glasses (if they have such capability).

Step 4) The biometric authentication data collected from previous step 3 is used in order to identify the user during key establishment. In a pre-shared secret scenario, then the biometric data may be used as a secret. For GBA, the biometric data can be used together with the mobile device identifier during GBA bootstrap. Other than that, the GBA session is performed as described in FIG. 1. (steps 3-8 of that flowchart). After step 8 in the GBA flowchart, we can move on to next step 5 in this flowchart. In a PKI solution the device can setup a direct secure channel towards the screen host. For privacy reasons, the biometric data can be hashed instead of using raw biometric data.

Step 5) Based on the biometric data, an OTP or information split unique to the user is generated locally on the device and displayed in the HUD of the glasses. On the terminal screen side, the complement to the HUD information is displayed. That is the encrypted data in case of visual cryptography scenario or the other information splits are displayed if visual obfuscation is used.

Step 6) User may have to manually align by moving and tilting his head so that the glasses overlay with the screen. Alternatively, an automated alignment is performed.

Step 7) (Optional) User interaction with the screen. In some use-cases, e.g., reading sensitive text or displaying images or shapes then interaction is not needed. If the user is interacting with the terminal screen, e.g., during authentication, then we may also utilize biometric authentication here as well. In this case, eye- and gaze tracking can be used in order for the user to input the credentials or OTAC. Haptics can be used in order to identify the user's screen touches in addition to the credentials or OTAC. This additional biometric is optional but can be used in combination with the visual cryptography and obfuscation scheme in order to make it harder for an adversary to capture credentials or to reuse the credentials.

As mentioned above the split parts of the present invention, could be used as part of a known authentication process in order to authorize a user to access authorized data. The split parts could e.g. be parts of encryption keys and decryption keys. However, it is also possible to utilize have traditional keys using symmetric or asymmetric crypto as well in order to protect the OTP provisioning to the user. Hence, the split parts per se do not have to be used as encryption keys or decryption keys. Since the OTP is random, it is possible to have keys or biometric authentication data used as seed input to the random OTP generator, i.e., something that links the user or the mobile device to the OTP.

### Abbreviations

| Abbreviation | Explanation |
|---|---|
| BSF/HSS | Bootstrapping Sever Function/Home Subscriber Server |
| HUD | Head-up display |
| CD | Content device |
| LC | Login container |
| KDF | Key derivation function |
| NFA | Network Application Functions |
| OTP | One-time pad |
| OTAC | One-time authorization code |
| GAA | Generic authentication architecture |
| GBA | Generic bootstrap architecture |
| PKI | Public Key Infrastructure |

### CLAUSES

Clause 1. Method for visual cryptography or obfuscation between a user device and a service/content provider, said user device comprising a user interface with display units, comprising the steps of:

establishing a session between the user device and the service/content provider;
exchanging encryption keys (could be done in advance);
creating N layers/parts of an image using the key, where all layers/parts are needed to read out the character;
presenting the different layers on different display units.

Clause 2. Method as in clause 1, wherein the layers are created as an OTP derived from the key and a visually encrypted image of the characters.

Clause 3. Method as in clause 2, further comprising receiving user input via the user interface comprising the one-time pad;

sending user input data to the receiver; and
decrypting the user input data at the receiver (encryption key pairs I and II).

Clause 4. Method as in clause 1, wherein the layers are created by splitting the characters into unencrypted parts.

Clause 5. Method as in clause 1, wherein a first display unit is of a non-transparent type (screen) and a second display unit is of a transparent type (glass).

Clause 6. Method as in clause 5, wherein the first display unit is using black and white sub-pixels, and the second display unit is using white and transparent sub-pixels.

Clause 7. Method as in clause 6, wherein N equals 3 and first display unit is an auto-stereoscopic display showing two of the parts and the second display unit shows the third part.

Clause 8. Method as in clause 6, wherein N equals 3 and first display unit is a polarized stereo display showing two of the parts and the second display unit shows the third part.

Clause 9. Method as in clause 1, wherein the image comprises characters, each character being split according to partitions of the digits which can have different probability to be chosen;

collecting these probabilities in a matrix denoted as a distribution matrix, thus obtaining several distribution matrices;
the provisioning comprising: 1) choosing one distribution matrix out of the several, 2) selecting one partition for each character in the matrix and 3) sending the parts to the different display units.

Clause 10. A user device comprising a mobile device with a screen and (smart) glasses interconnected, configured to perform relevant steps of the methods listed above.

Clause 11. A user device as in clause 10, wherein mobile device screen is auto-stereoscopic.

Clause 12. A user device as in clause 10 or 11, wherein software can reside in any or both of the mobile device and the glasses (smartglasses).

1. Method for preventing unauthorized viewing of at least one entity, comprising
accessing original data relating to the at least one entity from a database requiring authorized access;
splitting the at least one entity comprised in the original data or an encrypted version of the original data into at least a first split part and a second split part, wherein all of the split parts are required in order for allowing visualization of the full extent of the entity;
sending the first split part as image data to a display unit of a pair of video glasses worn by an authorized user; and
sending the second split part as image data to a second display unit, whereby a super positioning of the first display unit and the second display unit allow for visualizing the full extent of the entity.

2. The method according to claim 1, further comprising
establishing a session between a user device and a service/content provider; and exchanging encryption keys such as to allowing the accessing of original data.

3. The method according to claim 1, wherein the original data relates to an original image, and wherein the first split part is formed as a one-time-pad (OTP), the first split part OTP having a size at least corresponding to the size of the entity of the original image or larger, and wherein the second split part is formed as an encrypted image version of the original data.

4. The method according to claim 3, wherein the one-time-pad for the first split part is created by:
creating a temporary OTP having the same size as the original image with either a “one” or “zero” for each pixel position of the original image,
creating the first split part OTP by:
representing each pixel of the temporary OTP with at least four sub pixels forming a sub pixel matrix for each pixel of the temporary OTP, wherein the first split part OTP comprises each sub pixel matrix, wherein the first split part OTP has a size being at least four times larger than that of the temporary OTP, wherein
each “one” in the temporary OTP is represented by “white” sub pixels on a diagonal of the associated sub pixel matrix and with “transparent” pixels at the other positions of the associated sub pixel matrix, and wherein
a “zero” in the temporary OTP is represented by “transparent” pixels on another diagonal of the associated sub pixel matrix and with “white” pixels at the other positions of the associated sub pixel matrix.

5. The method according to claim 4, the second split part being created by:
creating an encrypted image of the original image, wherein the encrypted image comprises a number of encrypted sub pixel matrices, each encrypted sub pixel matrix being associated with one sub pixel matrix of the first split part OTP,
wherein each encrypted sub pixel matrix is represented by “black” sub pixels on the a diagonal thereof and with “white” sub pixels on the other positions thereof, such that
when the corresponding pixel of the original image is “white” and the sub pixels of the corresponding diagonal of the first split part OTP for the corresponding pixel is “white”, or when the corresponding pixel of the original image is “black” and the sub pixels of the corresponding diagonal of the first split part OTP for the corresponding pixel is “transparent” the sub pixels of the corresponding diagonal of the associated encrypted sub matrix are represented by “black” sub pixels and with “white” sub pixels on the other positions thereof, and otherwise the corresponding diagonal of associated encrypted sub matrix is represented by “white” sub pixels and with “black” sub pixels on the other positions thereof.

6. The method according to claim 1, wherein the at least one entity relates to at least one character, wherein the splitting comprises
splitting the character into several partitions, each split partition being associated with a unique probability of representing a specific character, wherein the unique probabilities for each partition are represented in a probability matrix, and wherein the probability matrices for all possible partitions are represented in an original probability distribution matrix.

7. The method according to claim 6, wherein the splitting further comprises
creating N number of new probability distribution matrices, wherein each new probability distribution matrix has probability entries being randomly changed in view of the corresponding to unique probability entries of the original probability distribution matrix.

8. The method according to claim 7, wherein the splitting further comprises
randomly selecting one of the N number of new probability distribution matrices and the original probability matrix;
sending at least one partition for the associated at least one character as a second split part as image data to the second display unit according to the selected probability distribution matrix,
sending the remaining partitions for the associated at least one character as a first split part as image data to the first display unit.

9. The method according to claim 1, wherein the splitting further comprises splitting up the at least one entity in a first split part, second split part and at least one further split part, and wherein the at least further split part is displayed on a third display unit.

10. The method according to claim 9, wherein the third display unit and the second display unit is comprised in a stereoscopic display unit being of an auto-stereoscopic or polarized stereo display type.

11. The method according to claim 9, wherein the third display unit and first display unit is comprised in the video glasses, optionally as two Head-Up-Displays (HUDs) arranged in the video glasses.

12. The method according to claim 1, wherein a first display unit is a transparent type and the second display unit is of a non-transparent type.

13. The method according to claim 3, further comprising receiving the first split part OTP and the second split part when the encryption keys between the user device and the as service/content provider have been exchanged.

14. The method according to claim 1, further comprising
sending the user input data to a receiver; and
receiving the user input data at the receiver, and at the receiver authorizing the user to access the authorized data when the user input data matches the at least one entity required.

15. The method according to claim 2, wherein the first split part OTP is used both as encryption and decryption key.

16. A user device comprising:
a first display unit of a pair of video glasses for use by an authorized user; and
a mobile device having a second display unit,
wherein the second display unit and the video glasses are interconnected,
and wherein the mobile device comprises processing circuitry configured to perform a method for preventing unauthorized viewing of at least one entity, wherein the method comprises:
accessing original data relating to the at least one entity from a database requiring authorized access;
splitting the at least one entity comprised in the original data or an encrypted version of the original data into at least a first split part and a second split part, wherein all of the split parts are required in order for allowing visualization of the full extent of the entity;
sending the first split part as image data to the first display unit of the pair of video glasses; and
sending the second split part as image data to the second display unit, whereby a super positioning of the first display unit and the second display unit allows for visualizing a full extent of the entity.

17. A user device according to claim 16, wherein the second display unit is auto-stereoscopic.

18. A user device according to claim 16, comprising software that is executed by the processing circuitry, and wherein the software resides in any or both of the mobile device and the video glasses.
